(19) United States
(12) Patent Application Publication
(10) Pub. No.: US 2023/0252206 A1
(43) Pub. Date: Aug. 10, 2023

(54) Simulation Model Validation for Structure Material Characterization

(71) Applicants: The Boeing Company, Chicago, IL (US); University of Washington, Seattle, WA (US)

(72) Inventors: Alan Douglas Byar, Issaquah, WA (US); John J. Dong, Seattle, WA (US); Mohammed H. Kabir, Seattle, WA (US); Alexandru I. Stere, Mukilteo, WA (US); Christina Doty, Seattle, WA (US); Ashith Joseph, Seattle, WA (US); Navid Zobeiry, Seattle, WA (US)

(21) Appl. No.: 17/648,526

(22) Filed: Jan. 20, 2022

(51) Int. Cl. G06F 30/27

(52) U.S. Cl. CPC G06F 30/27

(57) ABSTRACT

A method, apparatus, system, and computer program product for managing a physics simulation model. A machine learning model is trained to output predicted test results for sets of simulation values for a set of simulation parameters using a training data set based on test results for physical structures to form a surrogate model. Current simulation values for simulation parameters are selected using the surrogate model and a cost function. Simulation test results are generated using the physics simulation model that implements the current simulation values selected for the simulation parameters. The simulation test results are compared with physical test results from testing the set of physical structures using physical test inputs applied to the physical structures to form a comparison. The surrogate model is trained using the current simulation values selected for the simulation parameters using the surrogate model in response to the comparison being outside of a tolerance.

### BACKGROUND INFORMATION

### 1. Field

The present disclosure relates generally to characterizing materials... and in particular, to creating high fidelity physic based simulation models for testing physical structures using machine learning models.

### 2. Background

Engineering modeling and simulation can play an important role in product development in industries such as aerospace, automotive, and medical instrumentation. In developing products in these and other industries, product qualification and certification can be performed using physical testing or virtual simulation or both.

The use of simulations can provide significant reductions in prototype building physical testing. With the use of simulations, the fidelity of the simulation models is important. The fidelity of a simulation model can be the exactness at which the simulation model outputs data about a structure. When a desired level of fidelity is present for simulation model that simulates physical structures, that simulation models can be used in various operations which include testing, certification, and other operations with respect to product development.

### SUMMARY

An example of the present disclosure provides a model management system comprising a computer system and a model manager in the computer system. The model manager is configured to train a machine learning model to output predicted test results for sets of simulation values for a set of simulation parameters using a training data set determined based on test results for the set of physical structures to form a surrogate model. The model manager is configured to select a set of current simulation values for a set of simulation parameters using the surrogate model and a cost function. The model manager is configured to generate simulation test results using a physics simulation model that implements the set of current simulation values selected for the set of simulation parameters. The model manager is configured to compare the simulation test results with physical test results from testing the set of physical structures using physical test inputs applied to the set of physical structures to form a comparison. The model manager is configured to train the surrogate model using the set of current simulation values selected for the set of simulation parameters using the surrogate model in response to the comparison being outside of a tolerance.

Another example of the present disclosure provides a method for managing a physics simulation model. A computer system trains a machine learning model to output predicted test results for sets of simulation values for a set of simulation parameters using a training data set that has been determined based on test results for the set of physical structures, wherein the training of the machine learning model results in generation of a surrogate model. The computer system selects a set of current simulation values for a set of simulation parameters using the surrogate model and a cost function. The computer system generates simulation test results using the physics simulation model that implements the set of current simulation values selected for the set of simulation parameters. The computer system compares the simulation test results with physical test results from testing the set of physical structures using physical test inputs applied to the set of physical structures to form a comparison. The computer system trains the surrogate model using the set of current simulation values selected for the set of simulation parameters using the surrogate model in response to the comparison being outside of a tolerance.

Still another example of the present disclosure provides a computer program product for a physics simulation model, the computer program product comprising a computer readable storage medium having program instructions embodied therewith, the program instructions executable by a computer system to cause the computer system to perform a method of training, by the computer system, a machine learning model to output predicted test results for sets of simulation values for a set of simulation parameters using a training data set that has been determined based on test results for the set of physical structures, wherein the training of the machine learning model results in generation of a surrogate model; selecting, by the computer system, a set of current simulation values for a set of simulation parameters using the surrogate model and a cost function; generating, by the computer system, simulation test results using the physics simulation model that implements the set of current simulation values selected for the set of simulation parameters; comparing, by the computer system, the simulation test results with physical test results from testing the set of physical structures using physical test inputs applied to the set of physical structures to form a comparison; and training, by the computer system, the surrogate model using the set of current simulation values selected for the set of simulation parameters using the surrogate model in response to the comparison being outside of a tolerance.

The features and functions can be achieved independently in various examples of the present disclosure or may be combined in yet other examples in which further details can be seen with reference to the following description and drawings.

### BRIEF DESCRIPTION OF THE DRAWINGS

The novel features believed characteristic of the illustrative examples are set forth in the appended claims. The illustrative examples, however, as well as a preferred mode of use, further objectives and features thereof, will best be understood by reference to the following detailed description of an illustrative example of the present disclosure when read in conjunction with the accompanying drawings, wherein:

FIG. 1 a pictorial representation of a network of data processing systems in which illustrative examples may be implemented;

FIG. 2 is a block diagram of a modeling environment in accordance with an illustrative example;

FIGS. 3A-3B are an illustration of operations and data flow used to select simulation values for the physics simulation model in accordance with an illustrative example;

FIG. 4, an illustration of a first iteration for selecting simulation values is depicted in accordance with an illustrative example;

FIG. 5 is an illustration of a second iteration for selecting simulation values in accordance with an illustrative example;

FIG. 6 is an illustration of a third iteration for selecting simulation values in accordance with an illustrative example;

FIG. 7 is an illustration of a fourth iteration for selecting simulation values in accordance with an illustrative example;

FIG. 8 is an illustration a flowchart of a process for managing a physics simulation model in accordance with an illustrative example;

FIG. 9 is an illustration a flowchart of a process for managing a physics simulation model in accordance with an illustrative example;

FIG. 10 is an illustration a flowchart of a process for managing a physics simulation model in accordance with an illustrative example;

FIG. 11 is an illustration a flowchart of a process for selecting the set of current simulation values in accordance with an illustrative example;

FIG. 12 is an illustration of a block diagram of a data processing system in accordance with an illustrative example;

FIG. 13 is an illustration of an aircraft manufacturing and service method in accordance with an illustrative example;

FIG. 14 is an illustration of a block diagram of an aircraft in which an illustrative example may be implemented; and

FIG. 15 is an illustration of a block diagram of a product management system in accordance with an illustrative example.

### DETAILED DESCRIPTION

The illustrative examples recognize and take into account one or more different considerations. For example, those examples recognize and take into account that developing simulation models with the desired level of fidelity can be more difficult and time-consuming than desired. Thus, illustrative examples recognize and take into account that it would be desirable to have a method, apparatus, system and computer program product that take into account at least some of the issues discussed above, as well as other possible issues. For example, it would be desirable to have a method and apparatus that overcome a technical problem with reducing the time and effort needed to create simulation models.

The illustrative examples recognize and take into account that creating a simulation model with a desired level of accuracy or exactness involved obtaining data from extensive physical testing of structures for which the simulation model is to be created.

The illustrative examples also recognize and take into account that simulation models for simulating structures depend on various factors. For example, the illustrative examples recognize and take into account that in computational structure simulations, both material property parameters and model parameters can affect the accuracy of the model.

Illustrative examples recognize and take into account that the amounts of physical test data needed can be reduced through using both physical testing and machine learning to create simulation models. The illustrative examples recognize and take account that this approach reduce the amount of physical testing and virtual simulations performed to create a simulation model.

Thus, illustrative examples provide a method, apparatus, system, and computer program product for physical structure characterization. In one illustrative example, a computer system trains a machine learning model to output predicted test results for sets of simulation values for a set of simulation parameters using a training data set based on test results for the set of physical structures to form a surrogate model. The computer system selects a set of current simulation values for a set of simulation parameters using the surrogate model and a cost function. The computer system generates simulation test results using the physics simulation model that implements the set of current simulation values selected for the set of simulation parameters. The computer system compares the simulation test results with physical test results from testing the set of physical structures using physical test inputs applied to the set of physical structures to form a comparison. The computer system trains the surrogate model using the set of current simulation values selected for the set of simulation parameters using the surrogate model in response to the comparison being outside of a tolerance

As used herein, a “set of” when used with reference items means one or more items. For example, a set of physical structures is one or more physical structures.

Further, in the illustrative examples, a physics simulation model is a model that is based on physics properties or principles in contrast to non-physics-based for data-driven models. For example, a physics simulation model can be a finite element analysis model while a non-physics simulation model can be a machine learning model.

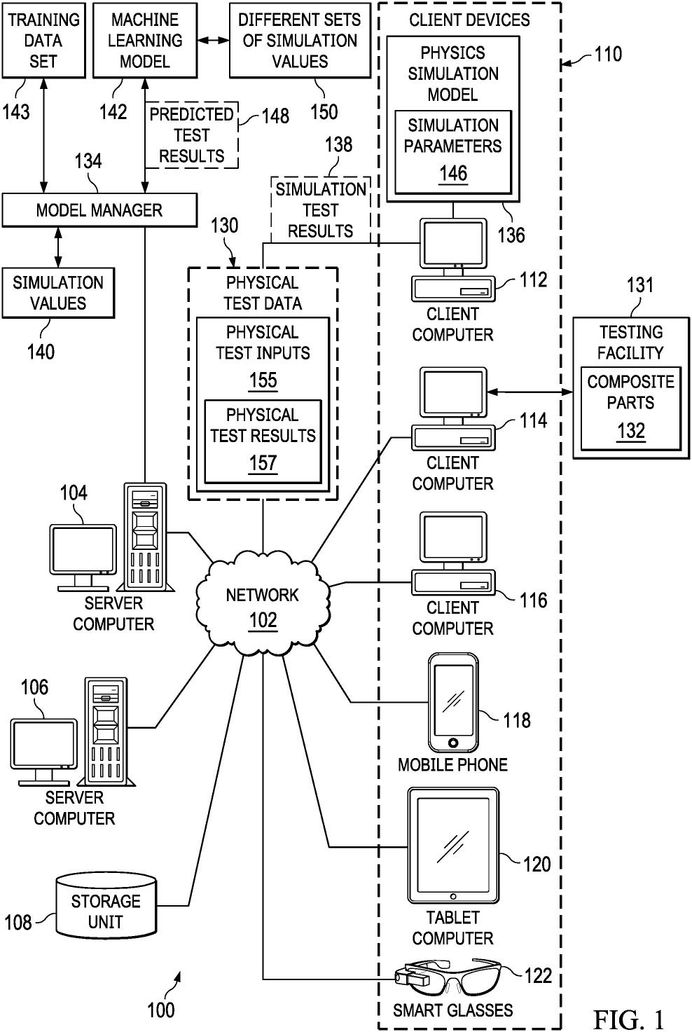

With reference now to the figures and, in particular, with reference to FIG. 1, a pictorial representation of a network of data processing systems is depicted in which illustrative examples may be implemented. Network data processing system 100 is a network of computers in which the illustrative examples may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client devices 110 connect to network 102. As depicted, client devices 110 include client computer 112, client computer 114, and client computer 116. Client devices 110 can be, for example, computers, workstations, or network computers. In the depicted example, server computer 104 provides information, such as boot files, operating system images, and applications to client devices 110. Further, client devices 110 can also include other types of client devices such as mobile phone 118, tablet computer 120, and smart glasses 122. In this illustrative example, server computer 104, server computer 106, storage unit 108, and client devices 110 are network devices that connect to network 102 in which network 102 is the communications media for these network devices. Some or all of client devices 110 may form an Internet of things (IoT) in which these physical devices can connect to network 102 and exchange information with each other over network 102.

Client devices 110 are clients to server computer 104 in this example. Network data processing system 100 may include additional server computers, client computers, and other devices not shown. Client devices 110 connect to network 102 utilizing at least one of wired, optical fiber, or wireless connections.

Program instructions located in network data processing system 100 can be stored on a computer-recordable storage media and downloaded to a data processing system or other device for use. For example, program instructions can be stored on a computer-recordable storage media on server computer 104 and downloaded to client devices 110 over network 102 for use on client devices 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational, and other computer systems that route data and messages. Of course, network data processing system 100 also may be implemented using a number of different types of networks. For example, network 102 can be comprised of at least one of the Internet, an intranet, a local area network (LAN), a metropolitan area network (MAN), or a wide area network (WAN). In this illustrative example, network data processing system 100 can be used to provide a cloud computing environment. FIG. 1 is intended as an example, and not as an architectural limitation for the different illustrative examples.

As used herein, “a number of” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combinations of these items can be present. In some illustrative examples, “at least one of” can be, for example, without limitation, two of item A; one of item B; and ten of item C; four of item B and seven of item C; or other suitable combinations.

As depicted, model manager 134 can manage models such as physics simulation model 136 running on client computer 112. As depicted, physics simulation model 136 can simulate testing of composite parts 132. In this illustrative example, physics simulation model 136 simulate testing of physical structures using on physics laws. For example, physics simulation model 136 can be fined element analysis (FEA) model.

In this illustrative example, composite parts 132 can take a number of different forms. For example, composite parts 132 can be selected from at least one of a test coupon, a prototype, a production part, or some other suitable type of composite part. Although this example describes the physical structures as composite parts 132, other illustrative examples can apply to other types of physical structures including test coupons, systems, a metal structure, or other type of physical structure.

In this illustrative example, model manager 134 can manage physics simulation model 136 by selecting simulation values 140 for simulation parameters 146 in physics simulation model 136. Simulation values 140 can be selected by model manager 134 as values for simulation parameters 146 in physics simulation model 136. Simulation parameters 146 can be, for example, at least one of a material parameter or a model parameter.

In the illustrative example, model manager 134 selects simulation values 140 for simulation parameters 146 and physics simulation model 136 in a manner that is at least one of faster, more efficient, or more accurate as compared to current techniques. As depicted, model manager 134 selects simulation values 140 using machine learning model 142. In this example, machine learning model 142 implements a regression algorithm, such as a Gaussian process progression (GPR) algorithm.

Model manager 134 trains machine learning model 142 using training data set 143 for different sets of simulation values 150. As depicted, training data set 143 is based on physical test data 130 generated through physical testing of composite parts 132 at testing facility 131.

Physical test data 130 comprises physical test inputs 155 applied to composite parts 132 and physical test results 157 detected in response to the physical test inputs 155. In this illustrative example, physical test data 130 is sent by client computer 114 at testing facility 131 to model manager 134 running on server computer 104.

When trained, machine learning model 142 outputs predicted test results 148 for different sets of simulation values 150. In other words, different sets of simulation values 150 result in different values for predicted test results 148.

In this illustrative example, model manager 134 selects simulation values 140 based on different sets of simulation values 150 and predicted test results 148 output for different sets of simulation values 150. The selection of simulation values 140 can be performed by model manager 134 using a process uses a curve based on predicted test results 148 to find a point on the curve that are closest to physical test results in physical test data 130. The values for the simulation parameters at this point on the curve is used as simulation values 140.

With the selection of simulation values 140, physics simulation model 136 can run a simulation for composite parts 132 using simulation values 140 for simulation parameters 146. The simulation performed by physics simulation model 204 can generate simulation test results 138. In this example, client computer 112 sends simulation test results 138 to model manager 134.

Model manager 134 compares simulation test results 138 with physical test results 157. If the difference between simulation test results 138 and physical test results 157 is within a desired tolerance, then simulation values 140 are used in physics simulation model 136 to perform simulations.

If the difference is not within the tolerance, then model manager 134 trains machine learning model 142 using simulation test results 138 generated using simulation values 140 selected using machine learning model 142. The training data set for the additional training comprises simulation test results 138 and simulation values 140 used to generate simulation test results 138. In this depicted example, simulation values 140 become part of different sets of simulation values 150 when used to further training machine learning model 142.

With this additional training of machine learning model 142, model manager 134 can select another set of values for simulation values 140 that provide are closest to physical test results 157 using predicted test results 148 for different sets of simulation values 150 with the updating or additional training of machine learning model 142.

The process can iteratively perform this process until a desired solution for simulation values 140 is identified. This process implemented in model manager 134 can be an optimization algorithm.

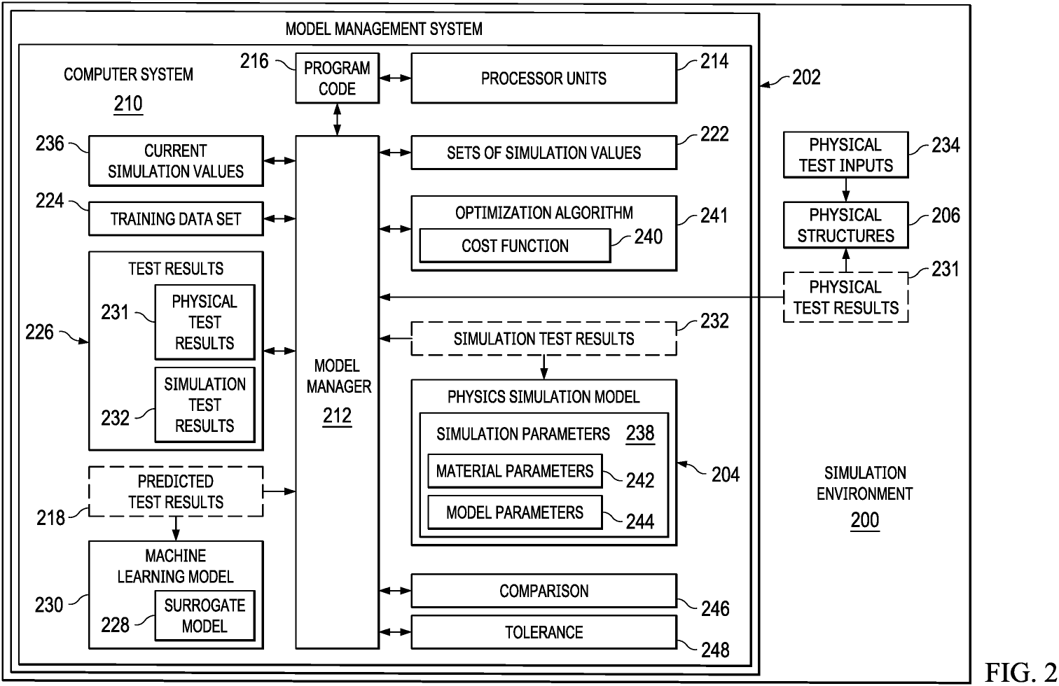

With reference now to FIG. 2, a block diagram of a modeling environment is depicted in accordance with an illustrative example. In this illustrative example, simulation environment 200 includes components that can be implemented in hardware such as the hardware shown in network data processing system 100 in FIG. 1.

In this illustrative example, model management system 202 in simulation environment 200 can operate to manage physics simulation model 204. The management can include at least one of creating, adjusting, or other management operations for physics simulation model 204. Physics simulation model 204 can be implemented using, for example, a finite element analysis program or model or a multi-physics simulation software package.

In this illustrative example, physics simulation model 204 is a simulation model of a set of physical structures 206. For example, physics simulation model 204 a finite element analysis (FEA) model, a computational fluid dynamics (CFD) model, a computational electromagnetics (CEM), or some other model based on one or more physics laws.

As depicted, model management system 202 can be comprised of computer system 210 and model manager 212. Model manager 212 is located in computer system 210.

Model manager 212 can be implemented in software, hardware, firmware or a combination thereof. When software is used, the operations performed by model manager 212 can be implemented in program instructions configured to run on hardware, such as a processor unit. When firmware is used, the operations performed by model manager 212 can be implemented in program instructions and data and stored in persistent memory to run on a processor unit. When hardware is employed, the hardware can include circuits that operate to perform the operations in model manager 212.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

Computer system 210 is a physical hardware system and includes one or more data processing systems. When more than one data processing system is present in computer system 210, those data processing systems are in communication with each other using a communications medium. The communications medium can be a network. The data processing systems can be selected from at least one of a computer, a server computer, a tablet computer, or some other suitable data processing system.

As depicted, computer system 210 includes a number of processor units 214 that are capable of executing program code 216 implementing processes in the illustrative examples. As used herein a processor unit in the number of processor units 214 is a hardware device and is comprised of hardware circuits such as those on an integrated circuit that respond and process instructions and program code that operate a computer. When a number of processor units 214 execute program code 216 for a process, the number of processor units 214 is one or more processor units that can be on the same computer or on different computers. In other words, the process can be distributed between processor units on the same or different computers in a computer system. Further, the number of processor units 214 can be of the same type or different type of processor units. For example, a number of processor units can be selected from at least one of a single core processor, a dual-core processor, a multi-processor core, a general-purpose central processing unit (CPU), a graphics processing unit (GPU), a digital signal processor (DSP), or some other type of processor unit.

As depicted, model manager 212 can train machine learning model 230 to output predicted test results 218 for sets of simulation values 222 for a set of simulation parameters 238 using a training data set 224 based on test results 226 for the set of physical structures 206 to form surrogate model 228.

Machine learning model 230 is a type of artificial intelligence model that can learn without being explicitly programmed. Machine learning model 230 can learn using on training data set 224.

In this illustrative example, machine learning model 230 can learn using various types of machine learning algorithms. The machine learning algorithms include at least one of a supervised learning, and unsupervised learning, reinforced learning, or other types of learning algorithms.

Machine learning model 230 can take a number different forms. In this illustrative example, machine learning model 230 can implement a regression algorithm. Machine learning model 230 can be selected from one of a Bayesian Gaussian process regression machine learning model, a neural network, a regression machine learning model, and other types machine learning models.

In its trained form, machine learning model 230 becomes surrogate model 228 in which this model is a surrogate for physics simulation model 204.

In this illustrative example, training data set 224 can also include physical test inputs 234 apply to physical structures 206. This application of physical test inputs 234 can be actual physical inputs when test results 226 includes physical test results 231 or can be simulated inputs when test results 226 includes simulation test results 232. Thus, training data set 224 can include physical test inputs 234 applied to the set of physical structures 206 and test results 226 from applying the set of physical test inputs 234 to the set of physical structures 206.

Test results 226 can take a number of different forms. For example, test results 226 can be selected from at least one of physical test results 231 or simulation test results 232. Physical test results 231 can be obtained from applying physical test inputs 234 to physical structures 206. Simulation test results 232 can be obtained from a simulation model, such as physics simulation model 204. Physical test inputs 234 can be real word physical test inputs for actual testing of physical structures 206 or physical test inputs 234 can be simulated when the testing is a simulation of the testing of physical structures 206.

In the illustrative example, model manager 212 selects a set of current simulation values 236 for a set of simulation parameters 238 using surrogate model 228 and cost function 240. The set of simulation parameters 238 can include at least one of a set of material parameters 242 or a set of model parameters 244.

The set of material parameters 242 can be selected from at least one of a ply thickness, ply orientation, a fracture toughness, a longitudinal compressive strength, a transverse compressive strength, a longitudinal tensile strength, a transverse tensile strength, a longitudinal shear strength, an in-plane shear yield stress, a hardening parameter for in plane shear classic to city, or some other suitable material parameters for the set of physical structures 206.

In this illustrative example, the set of model parameters 244 are variables for equations that model a system in physics simulation model 204. The set of model parameters 244 can be selected from at least one of a mesh type, a mesh size, an element type, an element size, an element shape, a mesh density, or some other model parameter.

Model manager 212 selects the set of current simulation values 236 for the set of simulation parameters 238 in which surrogate model 228 outputs predicted test results 218 closest to the physical test results 231 using cost function 240 in optimization algorithm 241.

In the illustrative example, cost function 240 is a function that can be used to reduce the distance between locations such as a curved line describing predicted test results 218 and physical test results 231. In other words, predicted test results 218 can form a curved line or the curved line can be fitted to predicted test results 218 and cost function 240 can be used to find the point in that curve that is closest to physical test results 231 for a particular set of current simulation values 236. That closest point represents current simulation values 236 that can be selected for the set of simulation parameters 238 and physics simulation model 204.

Optimization algorithm 241 can be selected from a number of different types of cost functions. For example, Optimization algorithm 241 can be selected from simulated annealing (SA), mean absolute error, mean squared error, root mean squared error, or other suitable types of cost functions.

Model manager 212 generates simulation test results 232 using physics simulation model 204 that implements the set of current simulation values 236 selected for the set of simulation parameters 238. Model manager 212 compares simulation test results 232 with physical test results 231 from testing the set of physical structures 206 using physical test inputs 234 applied to the set of physical structures 206 to form comparison 246.

Model manager 212 trains surrogate model 228 using the set of current simulation values 236 selected for the set of simulation parameters 238 using the surrogate model 228 in response to the comparison 246 being outside of tolerance 248. This training of surrogate model 228 is an updating or further training of the machine learning model to improve accuracy in predicted test results 218 output by surrogate model 228. In some illustrative examples, the current simulation values 236 and the simulation test results 232 can be added to training data set 224 and the entire training data set can be used to retrain machine learning model 230.

In this example, tolerance 248 can be a value such as a threshold or a range. For example, tolerance can be 0.1 precent. With this example, the difference between simulation test results 232 and physical test results 231 has an error of less than 0.1 precent, then comparison 246 is within the tolerance. In other illustrative examples, tolerance 248 can be a range of values.

In this depicted example, the set of material parameters 242 is one or more parameters that are variables describing the behavior of materials used in the set of physical structures 206 model by physics simulation model 204.

In the illustrative example, model manager 212 can repeat selecting the set of current simulation values 236 for the set of simulation parameters 238 and comparing the simulation test results 232 with physical test results 231 in response to comparison 246 being outside of tolerance 248. The additional training of machine learning model 230 can also be repeated in response to the comparison 246 being outside tolerance 248. As a result, model manager 212 can iteratively perform these operations to select current simulation values 236 that cause physics simulation model 204 to generate simulation test results 232 with a desired level of accuracy with respect to physical test results 231. This process can be performed automatically by model manager 212 without needing input from human operator. As result, the amount of time and effort needed to create or improve the performance of physics simulation model 204 can be reduced as compared to currently available techniques.

With physics simulation model 204 having current simulation values 236 that provide desired level of accuracy in performing simulations of tests on physical structures 206, physics simulation model 204 can be used to run simulations implementing the set of current simulation values 236 selected that resulted in comparison 246 being within tolerance 248.

In illustrative example, physics simulation model 204 can be used in performing a set of manufacturing operations. The set of manufacturing operations can take a number of different forms. For example, the set of manufacturing operations can be the set of manufacturing operations can comprise at least one of product certification and certification, prototype part manufacturing prototype, production part manufacturing, part design, simulation testing of a part, structural impact testing, or other types of manufacturing operations in which simulations of physical structures 206 can be used.

In one illustrative example, one or more technical solutions are present that overcome a technical problem with reducing the time and effort needed to create simulation models. One or more technical solutions can also enable increasing the accuracy of simulation models with reduced time and effort. One or more illustrative examples enable enables creating a simulation model with a smaller amount of physical test data as compared to current techniques.

Computer system 210 can be configured to perform at least one of the steps, operations, or actions described in the different illustrative examples using software, hardware, firmware or a combination thereof. As a result, computer system 210 operates as a special purpose computer system in which model manager 212 in computer system 210 enables improving the accuracy of simulation models. In particular, model manager 212 transforms computer system 210 into a special purpose computer system as compared to currently available general computer systems that do not have model manager 212.

In the illustrative example, the use of model manager 212 in computer system 210 integrates processes into a practical application for physical structure characterization using simulation models that have at simulation values for simulation parameters adjusted in the simulation models in a manner that increases the accuracy of the simulation models which in turn increases the performance of computer system 210 in performing physical structure characterizations. In other words, model manager 212 in computer system 210 is directed to a practical application of processes integrated into model manager 212 in computer system 210 that selects simulation values using a surrogate model for a physics simulation model.

The illustration of simulation environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, model manager 212 can be used to manage or select current simulation values for one or more physics simulation models in addition to or in place of physics simulation model 204.

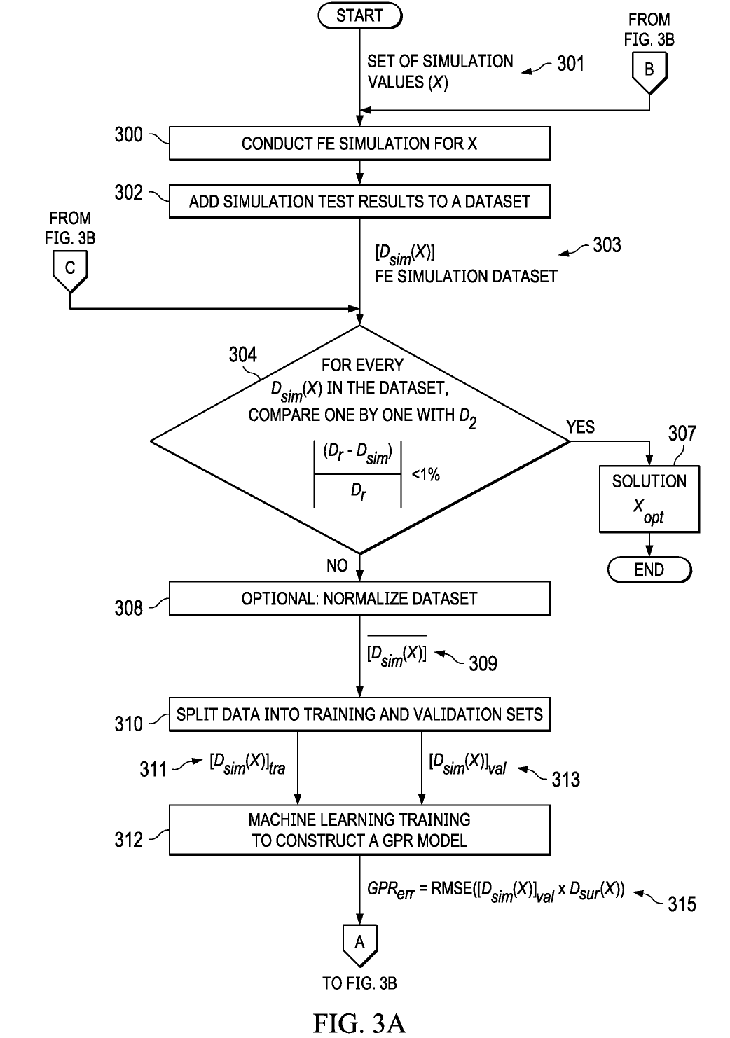

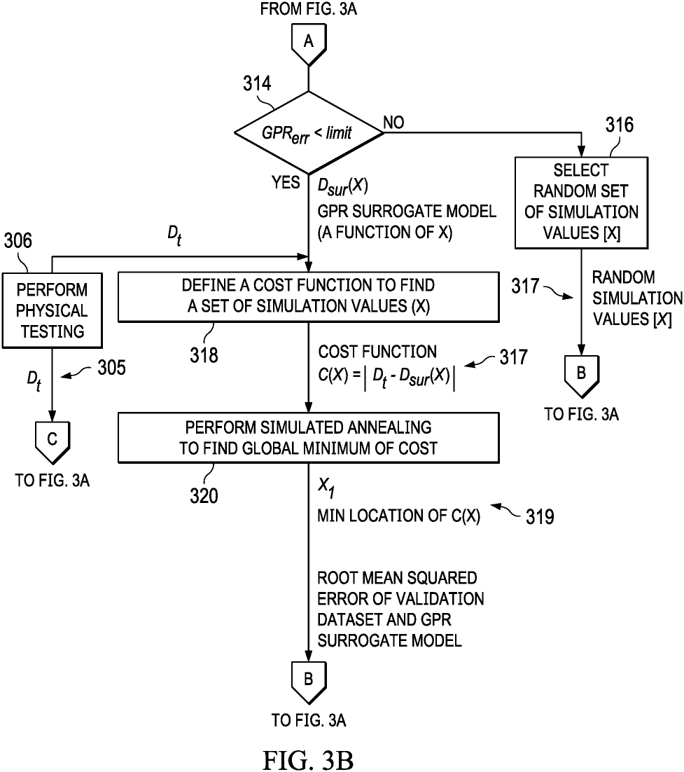

Turning to FIGS. 3A-3B, an illustration of operations and data flow used to select simulation values for the physics simulation model is depicted in accordance with an illustrative example. The process in FIGS. 3A-3B can be implemented in hardware, software, or both. When implemented in software, the process can take the form of program instructions that is run by one of more processor units located in one or more hardware devices in one or more computer systems. For example, the process can be implemented in model manager 212 in computer system 210 in FIG. 2.

In the illustrative example, the process starts with a set of simulation values (X) 301 being received for use in a FE simulation in operation 300. The process conducts a finite element (FE) analysis for the set of simulation values (X) 301 (operation 300).

The process adds simulation test results to a data set (operation 302). Operation 302 outputs [Dₛᵢₘ(X)] FE simulation data set 303 for use in operation 304. The process performs physical testing (operation 306). The result of this testing in operation 306 is physical test results Dₜ 305, which are sent to operation 304.

With these two inputs, [Dₛᵢₘ(X)] FE simulation data set 303 and Dₜ 305, for every Dₛᵢₘ(X)in the dataset, the comparison is performed one by one with Dₜ 305 to determine the following

$$\left|\frac{\left({D}_{t} - {D}_{s i m}\right)}{{D}_{t}}\right| < 1 \%$$

(operation 304). In operation 304, each simulation result Dₛᵢₘ is compared to the corresponding physical test result Dₜ.

In operation 304, the determination is as to whether the absolute value of the ratio of the difference between a physical test result in the corresponding simulation test result divided by the test result for a set of simulation values is within a desired level of less than 1 percent.

If the difference between all of the simulation test results and the physical test results is less than 1 percent in this example, the set of simulation values (X) for the simulation parameters is output as solution Xₒₚₜ 307 with the process terminating thereafter. The solution is identified as the most desirable set of simulation parameters for use in the physics simulation model that performs the finite element (FE) simulation.

Otherwise, the process normalizes the data set (operation 308). This operation is an optional step in this illustrative example. The output of this operation is

$$\overline{{D}_{s i m} \left(\overline{X}\right)} 309 ,$$

which is the normalized data set.

The process then splits the data set into training and validation data sets (operation 310). This operation outputs training data set [Dₛᵢₘ(X)]ₜᵣₐ 311 and validation training data set [Dₛᵢₘ(X)]ᵥₐₗ 313. Each of these data sets contains simulation results generated from the finite element (FE) simulation using the set of simulation values (X). In other illustrative examples, the training data for training the machine learning model can be physical testing results in addition to or in place of the simulation results.

The process then performs machine learning training (operation 312). The first time this operation is performed, and machine learning model is trained form a surrogate model. In this example, the machine learning model trained is a Gaussian process regression (GPR) model that is a surrogate for the physics simulation model. With a GPR model implementation, different GPR models can be constructed with different assumptions on the kernel using training data set [Dₛᵢₘ(X)]ₜᵣₐ 311. The best-performing GPR can be selected as GPR surrogate model and tested using validation training data set [Dₛᵢₘ(X)]ᵥₐₗ 313.

The output from operation 312 is a root mean square error of the validation data set and the GPR surrogate model, GPRₑᵣᵣ = RMSE ([Dₛᵢₘ(X)]ᵥₐₗ, Dₛᵤᵣ(X)) 315. A determination is made as to whether GPRₑᵣᵣ is less than a limit (operation 314). If the GPRₑᵣᵣ is not less than a limit, the process selects a random set of simulation values X (operation 316). Operation 316 outputs random simulation values [X] 317 for use in operation 300. In this case, new simulation inputs are selected for the process. In some illustrative examples, a preselected set of simulation values X can be used instead of a random set of simulation values X.

With reference again to operation 314, if the GPRₑᵣᵣ is less than the limit, the process defines a cost function to find to find the set of simulation values (X) (operation 318). In this illustrative example, operation 316 outputs cost function defined as follows: C(X) = |Dₜ -Dₛᵤᵣ(X)| 317, where Dₜ are physical test results and Dₛᵤᵣ(X) are the predicted test results generated by the surrogate model for a set of simulation values X.

The process performs simulated annealing to find the global minimum of cost (operation 320). In this operation, C(X) = |Dₜ - Dₛᵤᵣ(X)| 317 is used to find the set of simulation values X that minimizes the difference between these two sets of results. In other illustrative examples, other types of currently used optimization schemes can be used in place of simulated annealing.

In this illustrative example, operation 320 outputs Xᵢ 319 as the minimum location for the cost function, C(X) = |Dₜ - Dₛᵤᵣ(X)| 317. The process then returns to operation 300 to conduct a finite element simulation using Xᵢ 319 as the set of simulation values.

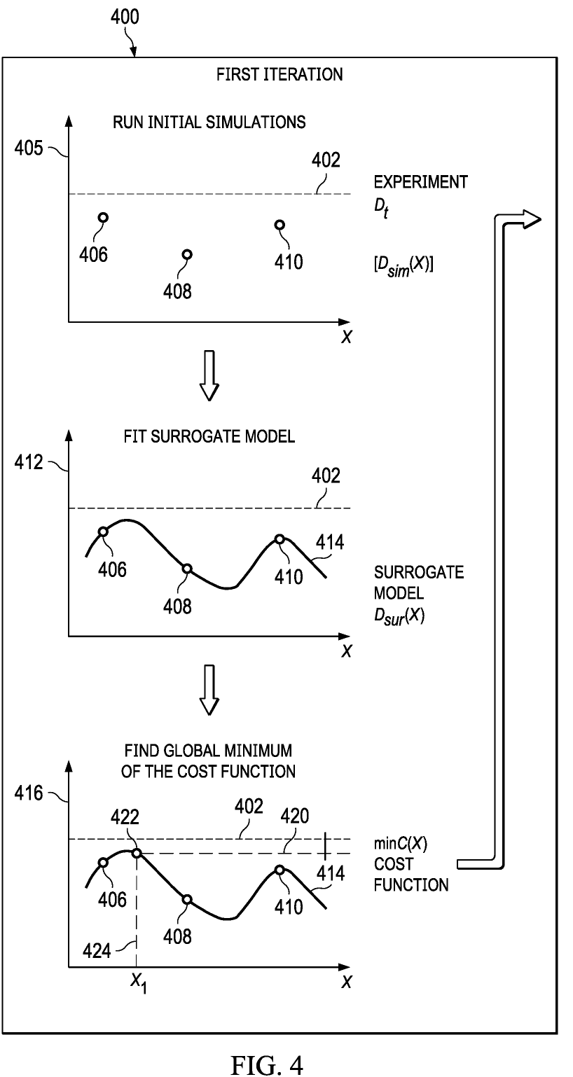

With reference to FIGS. 4-7, graphs illustrating iterations in selecting simulation values are depicted in accordance with an illustrative example. The graphs in these figures are examples of simulation values that can be selected using the process in the flowchart in FIGS. 3A-3B. In these depicted graphs, the X axis represents simulation values for a parameter, and the Y axis represents test results corresponding to simulation values on the X axis. Further, these graphs depict the selection of a single simulation value for a single simulation parameter. The process illustrated by these figures can be performed to identify simulation values for all simulation parameters.

Turning first to FIG. 4, an illustration of a first iteration for selecting simulation values is depicted in accordance with an illustrative example. As depicted, in first iteration 400, line 402 in graph 405 represents the physical test result Dₜ. Data point 406, data point 408, and data point 410 represent finite element simulation results performed using a simulation model implemented an initial set of simulation values for a simulation parameter. In this illustrative example, the simulation values can be random simulation values.

In graph 412, the processes the outputs of the surrogate on to the simulation data points Dₜ. Line 414 represents the output Dₛᵤᵣ(X) from the surrogate model. In this iteration, the surrogate model has been trained using data point 406, data point 408, and data points 410. This output is predicted test results based on the initial simulation value.

In graph 416, a cost function C(X) is used to find the global minimum is depicted by line 420. In this illustrative example, point 422 is the point on line 414 that is closest to the test results represented by line 402. As depicted, X₁ 424 is a simulation value for a simulation parameter that is selected based on the identification of point 422 on line 414.

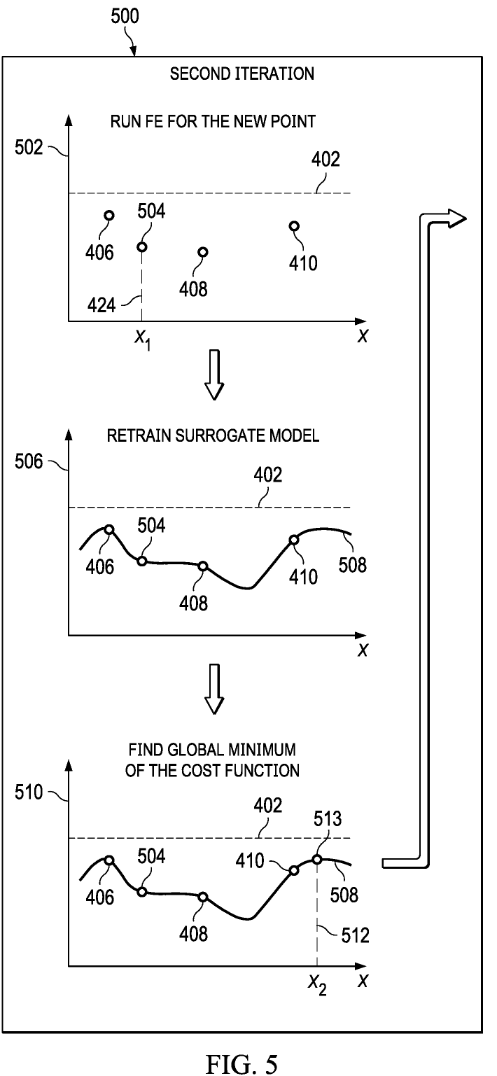

Turning next to FIG. 5, an illustration of a second iteration for selecting simulation values is depicted in accordance with an illustrative example. In the illustrative examples, the same reference numeral may be used in more than one figure. This reuse of a reference numeral in different figures represents the same element in the different figures.

In second iteration 500, X₁ 424 on the X axis is the simulation value of point 422 on line 414 in graph 416 in FIG. 4 and is added to the set of simulation values for a simulation parameter used the finite element analysis. As depicted, graph 502 shows data point 406, data point 408, data point 410, and data point 504 generated in a finance element analysis using different simulation values. Data point 504 is a data point generated by the finite element analysis performed using X₁ 424 as a simulation value.

In graph 506, line 508 represents the surrogate model trained using data point 406, data point 408, data point 410, and data point 504 along with the simulation values for those data points for the simulation parameter. In this illustrative example, the additional training is performed using the entire data set including the new data point. In other illustrative examples, the additional training can be performed using only the new data point.

Next, in graph 510, a global minimum is identified on line 508. This global minimum represents the smallest difference between a predicted test result on line 508 and the test data on line 402. In this illustrative example, this minimum is located at point 512 on line 508. In this example, X₂ 512 is the simulation value on the X axis for point 513. X₂ 512 is added to the set of simulation values for the simulation parameter is used in another finite element analysis in the next iteration in the process.

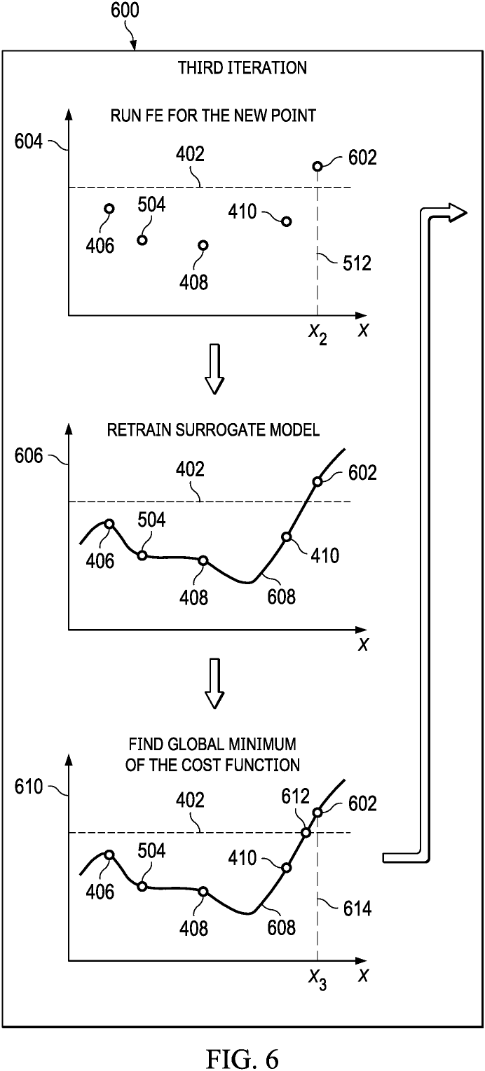

With reference to FIG. 6, an illustration of a third iteration for selecting simulation values is depicted in accordance with an illustrative example. In this depicted example, third iteration 600 includes the value for running the finite element analysis using the simulation values. In this example, the simulation value X2 at point 512 as an added to the set of simulation values for the parameter in running the finite element analysis in third iteration 600.

As depicted, the finite element analysis generates data point 406, data point 408, data point 410, data point 504, and data point 602 in graph 604. The survey model is retrained using data point 406, data point 408, data point 410, data point 504, and data point 602 and the simulation values for those data points. In graph 606, line 608 represents the predicted output generated by the surrogate model trained using the data points and simulation values for those data points.

In graph 610, point 612 is identified as the point having the minimum global cost. In other words, point 612 is the point having the smallest difference between the predicted test result in line 608 and the physical test result in line 402. In this illustrative example, point 612 on line 608 is also on line 402.

The simulation value of point 612 is X₃ 614 and is added to the set of simulation values running finite element analysis the next iteration.

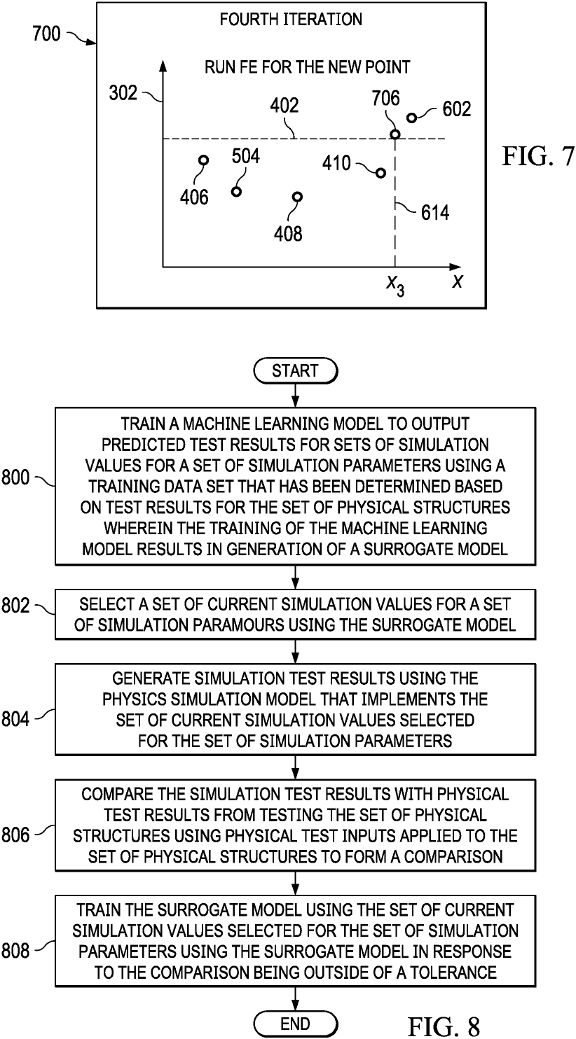

Turning now to FIG. 7, an illustration of a fourth iteration for selecting simulation values is depicted in accordance with an illustrative example. In fourth iteration 700, graph 702 shows data point 406, data point 408, data point 410, data point 504, data point 602, and data point 706. These data points are simulation test results generated in the finite element analysis using different simulation values.

In this depicted example, data point 706 is generated using X₃ 614 as the simulation value. In comparing data point 706 to line 402 for the test, data point 706 is considered sufficiently close to line 402. In other words, the simulation test result generated using X₃ 614 as the simulation value has a desired level of accuracy when compared to line 402 for the physical test result. As a result, additional iterations are no longer needed and X₃ 614 is the simulation value for the simulation model.

This process illustrated in FIGS. 4-7 can be performed for all of the simulation parameters of interest in a physics simulation model. Although shown as a two-dimensional process, this process can be implemented as a three-dimensional process in simulation values for the simulation parameters are all processed in parallel at the same time or substantially the same time. In other words, additional dimensions can be used to represent any number of materials of interest on the x-axis as well as any number of experimental results on the y-axis.

The illustration of the process in FIGS. 4-7 is intended to illustrate one manner in which simulation values can be determined for use in a physics simulation model. This illustration is not meant to limit the manner in which other illustrative examples can be implemented. For example, the machine learning model in this example is trained using test results from a simulation such as a finite element analysis. In other illustrative examples, the machine learning model can be trained using actual physical test results. Updates or retraining of the sheen learning model can be performed using simulation results in addition to the physical test results.

With reference next to FIG. 8, an illustration a flowchart of a process for managing a physics simulation model is depicted in accordance with an illustrative example. The process in FIG. 8 can be implemented in hardware, software, or both. When implemented in software, the process can take the form of program instructions that is run by one of more processor units located in one or more hardware devices in one or more computer systems. For example, the process can be implemented in model manager 212 in computer system 210 in FIG. 2.

The process begins by training a machine learning model to output predicted test results for sets of simulation values for a set of simulation parameters using a training data set based on test results for the set of physical structures to form a surrogate model (operation 800). The process selects a set of current simulation values for a set of simulation parameters using the surrogate model and a cost function (operation 802) .

The process generates simulation test results using the physics simulation model that implements the set of current simulation values selected for the set of simulation parameters (operation 804). The process compares the simulation test results with physical test results from testing the set of physical structures using physical test inputs applied to the set of physical structures to form a comparison (operation 806).

The process trains the surrogate model using the set of current simulation values selected for the set of simulation parameters using the surrogate model in response to the comparison being outside of a tolerance (operation 808). The process terminates thereafter.

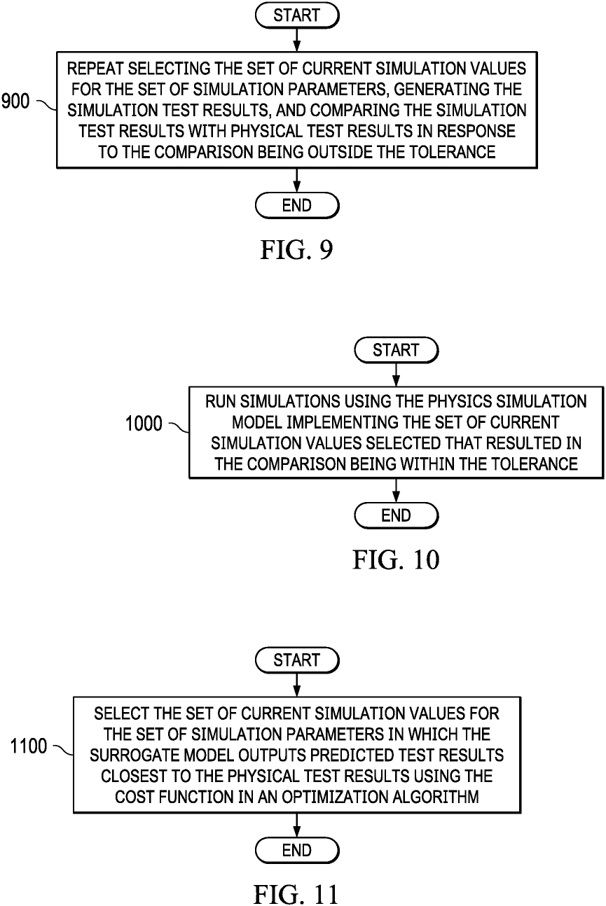

Turning next to FIG. 9, an illustration a flowchart of a process for managing a physics simulation model is depicted in accordance with an illustrative example. The process illustrated in this figure is an example of an additional operation that can be performed with the operations in FIG. 8.

The process repeats selecting the set of current simulation values for the set of simulation parameters, generating the simulation test results, and comparing the simulation test results with physical test results in response to the comparison being outside of the tolerance (operation 900). The process terminates thereafter. In operation 900, the process can cause operations 802, operation 804, and operation 806 in FIG. 8 to be repeated when the output from the physics simulation model is not sufficiently accurate when that output is compared to the physics test results from testing or experiments performed on the school structures.

In FIG. 10, an illustration a flowchart of a process for managing a physics simulation model is depicted in accordance with an illustrative example. The process illustrated in FIG. 10 is an example of an additional operation that can be performed with the operations in FIG. 8.

The process runs simulations using the physics simulation model implementing the set of current simulation values selected that resulted in the comparison being with in the tolerance (operation 1000). The process terminates thereafter.

With reference next to FIG. 11, an illustration a flowchart of a process for selecting the set of current simulation values is depicted in accordance with an illustrative example. The process depicted in this figure is an example of one implementation for operation 802 in FIG. 8.

The process selects the set of current simulation values for the set of simulation parameters in which the surrogate model outputs predicted test results closest to the physical test results using the cost function in an optimization algorithm (operation 1100). The process terminates thereafter.

The flowcharts and block diagrams in the different depicted examples illustrate the architecture, functionality, and operation of some possible implementations of apparatuses and methods in an illustrative example. In this regard, each block in the flowcharts or block diagrams can represent at least one of a module, a segment, a function, or a portion of an operation or step. For example, one or more of the blocks can be implemented as program code, hardware, or a combination of the program code and hardware. When implemented in hardware, the hardware can, for example, take the form of integrated circuits that are manufactured or configured to perform one or more operations in the flowcharts or block diagrams. When implemented as a combination of program code and hardware, the implementation may take the form of firmware. Each block in the flowcharts or the block diagrams can be implemented using special purpose hardware systems that perform the different operations or combinations of special purpose hardware and program code run by the special purpose hardware.

In some alternative implementations of an illustrative example, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

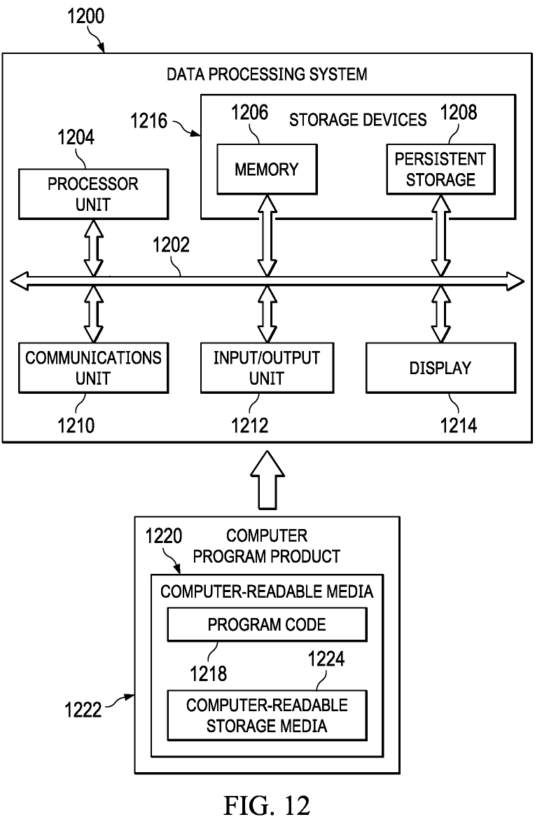

Turning now to FIG. 12, an illustration of a block diagram of a data processing system is depicted in accordance with an illustrative example. Data processing system 1200 can be used to implement server computer 104, server computer 106, client devices 110, in FIG. 1. Data processing system 1200 can also be used to implement computer system 210 in FIG. 2. In this illustrative example, data processing system 1200 includes communications framework 1202, which provides communications between processor unit 1204, memory 1206, persistent storage 1208, communications unit 1210, input/output (I/O) unit 1212, and display 1214. In this example, communications framework 1202 takes the form of a bus system.

Processor unit 1204 serves to execute instructions for software that can be loaded into memory 1206. Processor unit 1204 includes one or more processors. For example, processor unit 1204 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1204 can may be implemented using one or more heterogeneous processor systems in which a main processor is present with secondary processors on a single chip. As another illustrative example, processor unit 1204 can be a symmetric multi-processor system containing multiple processors of the same type on a single chip.

Memory 1206 and persistent storage 1208 are examples of storage devices 1216. A storage device is any piece of hardware that is capable of storing information, such as, for example, without limitation, at least one of data, program code in functional form, or other suitable information either on a temporary basis, a permanent basis, or both on a temporary basis and a permanent basis. Storage devices 1216 may also be referred to as computer-readable storage devices in these illustrative examples. Memory 1206, in these examples, can be, for example, a random-access memory or any other suitable volatile or non-volatile storage device. Persistent storage 1208 can take various forms, depending on the particular implementation.

For example, persistent storage 1208 may contain one or more components or devices. For example, persistent storage 1208 can be a hard drive, a solid-state drive (SSD), a flash memory, a rewritable optical disk, a rewritable magnetic tape, or some combination of the above. The media used by persistent storage 1208 also can be removable. For example, a removable hard drive can be used for persistent storage 1208.

Communications unit 1210, in these illustrative examples, provides for communications with other data processing systems or devices. In these illustrative examples, communications unit 1210 is a network interface card.

Input/output unit 1212 allows for input and output of data with other devices that can be connected to data processing system 1200. For example, input/output unit 1212 can provide a connection for user input through at least one of a keyboard, a mouse, or some other suitable input device. Further, input/output unit 1212 can send output to a printer. Display 1214 provides a mechanism to display information to a user.

Instructions for at least one of the operating system, applications, or programs can be located in storage devices 1216, which are in communication with processor unit 1204 through communications framework 1202. The processes in the different examples can be performed by processor unit 1204 using computer-implemented instructions, which can be located in a memory, such as memory 1206.

These instructions are program instructions and are also referred to as program code, computer usable program code, or computer-readable program code that can be read and executed by a processor in processor unit 1204. The program code in the different examples can be embodied on different physical or computer-readable storage media, such as memory 1206 or persistent storage 1208.

Program code 1218 is located in a functional form on computer-readable media 1220 that is selectively removable and can be loaded onto or transferred to data processing system 1200 for execution by processor unit 1204. Program code 1218 and computer-readable media 1220 form computer program product 1222 in these illustrative examples. In the illustrative example, computer-readable media 1220 is computer-readable storage media 1224.

Computer-readable storage media 1224 is a physical or tangible storage device used to store program code 1218 rather than a media that propagates or transmits program code 1218. Computer-readable storage media 1224, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program code 1218 can be transferred to data processing system 1200 using a computer-readable signal media. The computer-readable signal media are signals and can be, for example, a propagated data signal containing program code 1218. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1220” can be singular or plural. For example, program code 1218 can be located in computer-readable media 1220 in the form of a single storage device or system. In another example, program code 1218 can be located in computer-readable media 1220 that is distributed in multiple data processing systems. In other words, some instructions in program code 1218 can be located in one data processing system while other instructions in program code 1218 can be located in one data processing system. For example, a portion of program code 1218 can be located in computer-readable media 1220 in a server computer while another portion of program code 1218 can be located in computer-readable media 1220 located in a set of client computers.

The different components illustrated for data processing system 1200 are not meant to provide architectural limitations to the manner in which different examples can be implemented. In some illustrative examples, one or more of the components may be incorporated in or otherwise form a portion of, another component. For example, memory 1206, or portions thereof, can be incorporated in processor unit 1204 in some illustrative examples. The different illustrative examples can be implemented in a data processing system including components in addition to or in place of those illustrated for data processing system 1200. Other components shown in FIG. 12 can be varied from the illustrative examples shown. The different examples can be implemented using any hardware device or system capable of running program code 1218.

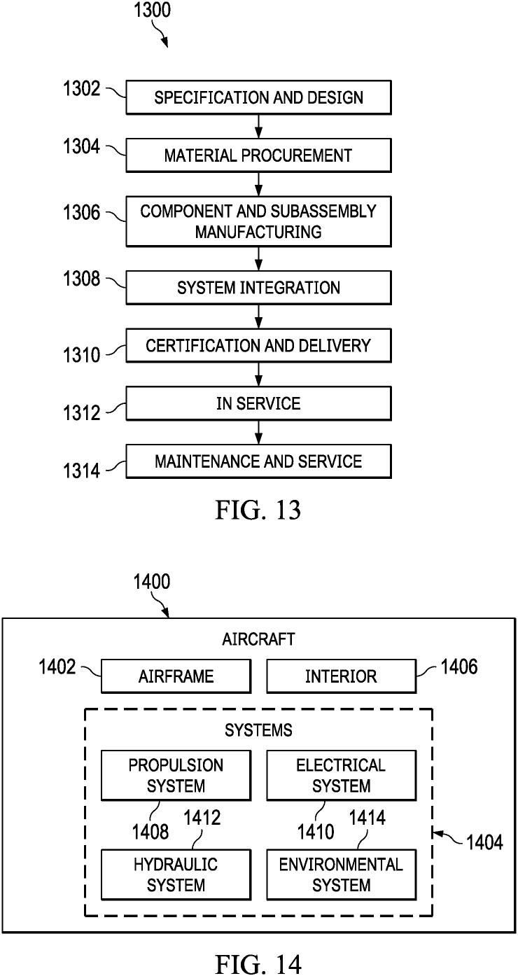

Illustrative examples of the disclosure may be described in the context of aircraft manufacturing and service method 1300 as shown in FIG. 13 and aircraft 1400 as shown in FIG. 14. Turning first to FIG. 13, an illustration of an aircraft manufacturing and service method is depicted in accordance with an illustrative example. During pre-production, aircraft manufacturing and service method 1300 may include specification and design 1302 of aircraft 1400 in FIG. 14 and material procurement 1304.

During production, component and subassembly manufacturing 1306 and system integration 1308 of aircraft 1400 in FIG. 14 takes place. Thereafter, aircraft 1400 in FIG. 14 can go through certification and delivery 1310 in order to be placed in service 1312. While in service 1312 by a customer, aircraft 1400 in FIG. 14 is scheduled for routine maintenance and service 1314, which may include modification, reconfiguration, refurbishment, and other maintenance or service.

Each of the processes of aircraft manufacturing and service method 1300 may be performed or carried out by a system integrator, a third party, an operator, or some combination thereof. In these examples, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 14, an illustration of an aircraft is depicted in which an illustrative example may be implemented. In this example, aircraft 1400 is produced by aircraft manufacturing and service method 1300 in FIG. 13 and may include airframe 1402 with plurality of systems 1404 and interior 1406. Examples of systems 1404 include one or more of propulsion system 1408, electrical system 1410, hydraulic system 1412, and environmental system 1414. Any number of other systems may be included. Although an aerospace example is shown, different illustrative examples may be applied to other industries, such as the automotive industry.

Apparatuses and methods embodied herein may be employed during at least one of the stages of aircraft manufacturing and service method 1300 in FIG. 13.

In one illustrative example, components or subassemblies produced in component and subassembly manufacturing 1306 in FIG. 13 can be fabricated or manufactured in a manner similar to components or subassemblies produced while aircraft 1400 is in service 1312 in FIG. 13. As yet another example, one or more apparatus examples, method examples, or a combination thereof can be utilized during production stages, such as component and subassembly manufacturing 1306 and system integration 1308 in FIG. 13. One or more apparatus examples, method examples, or a combination thereof may be utilized while aircraft 1400 is in service 1312, during maintenance and service 1314 in FIG. 13, or both. The use of a number of the different illustrative examples may substantially expedite the assembly of aircraft 1400, reduce the cost of aircraft 1400, or both expedite the assembly of aircraft 1400 and reduce the cost of aircraft 1400.

For example, model management system 202 in FIG. 2 can be used to create simulation models for use in performing testing, certification, and other processes for manufacturing aircraft 1400. Model management system 202 can be used to create an update simulation models used during at least one of specification and design 1302, certification and delivery 1310, and maintenance and service 1314. Additionally, model management system 202 in FIG. 2 can also be used during component and subassembly manufacturing 1306, to perform simulations along with physical testing of parts, components, and subassemblies.

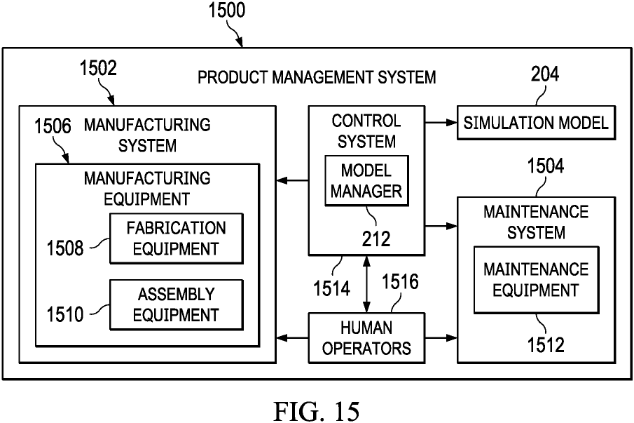

Turning now to FIG. 15, an illustration of a block diagram of a product management system is depicted in accordance with an illustrative example. Product management system 1500 is a physical hardware system. In this illustrative example, product management system 1500 includes at least one of manufacturing system 1502 or maintenance system 1504.

Manufacturing system 1502 is configured to manufacture products, such as aircraft 1400 in FIG. 14. As depicted, manufacturing system 1502 includes manufacturing equipment 1506. Manufacturing equipment 1506 includes at least one of fabrication equipment 1508 or assembly equipment 1510.

Fabrication equipment 1508 is equipment that used to fabricate components for parts used to form aircraft 1400 in FIG. 14. For example, fabrication equipment 1508 can include machines and tools. These machines and tools can be at least one of a drill, a hydraulic press, a furnace, an autoclave, a mold, a composite tape laying machine, an automated fiber placement (AFP) machine, a vacuum system, a robotic pick and place system, a flatbed cutting machine, a laser cutter, a computer numerical control (CNC) cutting machine, a lathe, or other suitable types of equipment. Fabrication equipment 1508 can be used to fabricate at least one of metal parts, composite parts, semiconductors, circuits, fasteners, ribs, skin panels, spars, antennas, or other suitable types of parts.

Assembly equipment 1510 is equipment used to assemble parts to form aircraft 1400 in FIG. 14. In particular, assembly equipment 1510 is used to assemble components and parts to form aircraft 1400 in FIG. 14. Assembly equipment 1510 also can include machines and tools. These machines and tools may be at least one of a robotic arm, a crawler, a faster installation system, a rail-based drilling system, or a robot. Assembly equipment 1510 can be used to assemble parts such as seats, horizontal stabilizers, wings, engines, engine housings, landing gear systems, and other parts for aircraft 1400 in FIG. 14.

In this illustrative example, maintenance system 1504 includes maintenance equipment 1512. Maintenance equipment 1512 can include any equipment needed to perform maintenance on aircraft 1400 in FIG. 14. Maintenance equipment 1512 may include tools for performing different operations on parts on aircraft 1400 in FIG. 14. These operations can include at least one of disassembling parts, refurbishing parts, inspecting parts, reworking parts, manufacturing replacement parts, or other operations for performing maintenance on aircraft 1400 in FIG. 14. These operations can be for routine maintenance, inspections, upgrades, refurbishment, or other types of maintenance operations.

In the illustrative example, maintenance equipment 1512 may include ultrasonic inspection devices, x-ray imaging systems, vision systems, drills, crawlers, and other suitable devices. In some cases, maintenance equipment 1512 can include fabrication equipment 1508, assembly equipment 1510, or both to produce and assemble parts that needed for maintenance.

Product management system 1500 also includes control system 1514. Control system 1514 is a hardware system and may also include software or other types of components. Control system 1514 is configured to control the operation of at least one of manufacturing system 1502 or maintenance system 1504. In particular, control system 1514 can control the operation of at least one of fabrication equipment 1508, assembly equipment 1510, or maintenance equipment 1512.

The hardware in control system 1514 can be implemented using hardware that may include computers, circuits, networks, and other types of equipment. The control may take the form of direct control of manufacturing equipment 1506. For example, robots, computer-controlled machines, and other equipment can be controlled by control system 1514. In other illustrative examples, control system 1514 can manage operations performed by human operators 1516 in manufacturing or performing maintenance on aircraft 1400. For example, control system 1514 can assign tasks, provide instructions, display models, or perform other operations to manage operations performed by human operators 1516. In these illustrative examples, model manager 212 in FIG. 2 can be implemented be implemented in control system 1514 to manage physics simulation model 204. For example, model manager 212 can create an update physics simulation model 204 to have a desired level accuracy for use in performing various manufacturing operations within product management system 1500. For example, physics simulation model 204 can be used to generate simulation test data for various components, subassemblies, and assemblies. This test data can use for certification and other purposes in manufacturing a product using product management system 1500.

In the different illustrative examples, human operators 1516 can operate or interact with at least one of manufacturing equipment 1506, maintenance equipment 1512, or control system 1514. This interaction can occur to manufacture aircraft 1400 in FIG. 14.

Of course, product management system 1500 may be configured to manage other products other than aircraft 1400 in FIG. 14. Although product management system 1500 has been described with respect to manufacturing in the aerospace industry, product management system 1500 can be configured to manage products for other industries. For example, product management system 1500 can be configured to manufacture products for the automotive industry as well as any other suitable industries.

Some features of the illustrative examples are described in the following clauses. These clauses are examples of features not intended to limit other illustrative examples.

### Clause 1

A model management system comprising:
a computer system;
a model manager in the computer system, wherein the model manager is configured to:
train a machine learning model to output predicted test results for sets of simulation values for a set of simulation parameters using a training data set determined based on test results for a set of physical structures to form a surrogate model;
select a set of current simulation values for the set of simulation parameters using the surrogate model and a cost function;
generate simulation test results using a physics simulation model that implements the set of current simulation values selected for the set of simulation parameters;
compare the simulation test results with physical test results from testing the set of physical structures using physical test inputs applied to the set of physical structures to form a comparison; and
train the surrogate model using the set of current simulation values selected for the set of simulation parameters using the surrogate model in response to the comparison being outside of a tolerance.

### Clause 2

The model management system according to clause, wherein the model manager is configured to:

repeat selecting the set of current simulation values for the set of simulation parameters, generating the simulation test results, and comparing the simulation test results with the test results in response to the comparison being outside of the tolerance.

### Clause 3

The model management system according to one of clauses 1 or 2, wherein in selecting the set of current simulation values for the set of simulation parameters using the surrogate model and the cost function, the model manager is configured to:

select the set of current simulation values for the set of simulation parameters in which the surrogate model outputs predicted test results closest to the physical test results using the cost function in an optimization algorithm.

### Clause 4

The model management system according to one of clauses 1, 2, or 3, wherein the model manager is configured to:

run simulations using the physics simulation model implementing the set of current simulation values selected that resulted in the comparison being with in the tolerance.

### Clause 5

The model management system according to one of clauses 1, 2, 3, or 4, wherein the training data set comprises physical test inputs applied to the set of physical structures and test results from applying a set of the physical test inputs to the set of physical structures, wherein the machine learning model outputs the predicted test results in response to physical test inputs input into the machine learning model.

### Clause 6

The model management system according to one of clauses 1, 2, 3, 4, or 5, wherein the machine learning model is selected from one of a Bayesian Gaussian process regression machine learning model, a neural network, and a regression machine learning model.

### Clause 7

The model management system according to one of clauses 1, 2, 3, 4, 5, or 6, wherein the physics simulation model is one of a finite element analysis (FEA) model, a computational fluid dynamics (CFD) model, and a computational electromagnetics (CEM) model.

### Clause 8

The model management system according to one of clauses 1, 2, 3, 4, 5, 6, or 7, wherein the set of simulation parameters is selected from at least one of a material parameter or a model parameter.

### Clause 9

The model management system according to one of clauses 1, 2, 3, 4, 5, 6, 7, or 8, wherein the set of current simulation values is selected from at least one of a material value or a model value.

### Clause 10

A method for managing a physics simulation model, the method comprising:
training, by a computer system, a machine learning model to output predicted test results for sets of simulation values for a set of simulation parameters using a training data set that has been determined based on test results for a set of physical structures), wherein the training of the machine learning model results in generation of a surrogate model;
selecting, by the computer system, a set of current simulation values for the set of simulation parameters using the surrogate model and a cost function;
generating, by the computer system, simulation test results using the physics simulation model that implements the set of current simulation values selected for the set of simulation parameters;
comparing, by the computer system, the simulation test results with physical test results from testing the set of physical structures using physical test inputs applied to the set of physical structures to form a comparison; and
training, by the computer system, the surrogate model using the set of current simulation values selected for the set of simulation parameters using the surrogate model in response to the comparison being outside of a tolerance.

### Clause 11

The method according to clause 10 further comprising:

repeating, by the computer system, selecting the set of current simulation values for the set of simulation parameters, generating the simulation test results, and comparing the simulation test results with the test results in response to the comparison being outside of the tolerance.

### Clause 12

The method according to one of clauses 10 or 11, wherein selecting the set of current simulation values for the set of simulation parameters using the surrogate model and the cost function comprises:

selecting, by the computer system, the set of current simulation values for the set of simulation parameters in which the surrogate model outputs predicted test results closest to the physical test results using the cost function in an optimization algorithm.

### Clause 13

The method according to one of clauses 10, 11, or 12, further comprising:

running, by the computer system, simulations using the physics simulation model implementing the set of current simulation values selected that resulted in the comparison being with in the tolerance.

### Clause 14

The method according to one of clauses 10, 11, 12, or 13, wherein the training data set comprises physical test inputs applied to the set of physical structures and test results from applying a set of the physical test inputs to the set of physical structures, wherein the machine learning model outputs the predicted test results in response to physical test inputs input into the machine learning model.

### Clause 15

The method according to one of clauses 10, 11, 12, 13, or 14, wherein the machine learning model is selected from one of a Bayesian Gaussian process regression machine learning model, a neural network, and a regression machine learning model.

### Clause 16

The method according to one of clauses 10, 11, 12, 13, 14, or 15, wherein the physics simulation model is one of a finite element analysis (FEA) model, a computational fluid dynamics (CFD) model, and a computational electromagnetics (CEM) model.

### Clause 17

The method according to one of clauses 10, 11, 12, 13, 14, 15, or 16, wherein the set of simulation parameters is selected from at least one of a material parameter or a model parameter and wherein current simulation values is selected from at least one of a material value or a model value.

### Clause 18

A computer program product for managing a physics simulation model, the computer program product comprising a computer readable storage medium having program code embodied therewith, the program code executable by a computer system to cause the computer system to perform a method of:
training, by the computer system, a machine learning model to output predicted test results for sets of simulation values for a set of simulation parameters using a training data set that has been determined based on test results for a set of physical structures, wherein the training of the machine learning model results in generation of a surrogate model;
selecting, by the computer system, a set of current simulation values for the set of simulation parameters using the surrogate model and a cost function;
generating, by the computer system, simulation test results using the physics simulation model that implements the set of current simulation values selected for the set of simulation parameters;
comparing, by the computer system, the simulation test results with physical test results from testing the set of physical structures using physical test inputs applied to the set of physical structures to form a comparison; and
training, by the computer system, the surrogate model using the set of current simulation values selected for the set of simulation parameters using the surrogate model in response to the comparison being outside of a tolerance.

### Clause 19

The computer program product according to clause 18 further comprising:

repeating, by the computer system, selecting the set of current simulation values for the set of simulation parameters, generating the simulation test results, and comparing the simulation test results with the test results in response to the comparison being outside of the tolerance.

### Clause 20

The computer program product according to one of clauses 18 or 19, wherein selecting the set of current simulation values for the set of simulation parameters using the surrogate model and the cost function comprises:

selecting, by the computer system, the set of current simulation values for the set of simulation parameters in which the surrogate model outputs predicted test results closest to the physical test results using the cost function in an optimization algorithm.

Thus, one or more illustrative examples provide A method, apparatus, system, and computer program product for physical structure characterization. A machine learning model is trained using a training data set comprising differences between physical test data generated from physical testing of a set of physical structures and simulation test data generated from a simulation model of the set of physical structures in which the simulation model has a set of material parameters. A set of material values is received for the set of material parameters output by the machine learning model trained using the training data set. The set of material parameters is adjusted in the simulation model using the set of material values.

The description of the different illustrative examples has been presented for purposes of illustration and description and is not intended to be exhaustive or limited to the examples in the form disclosed. The different illustrative examples describe components that perform actions or operations. In an illustrative example, a component can be configured to perform the action or operation described. For example, the component can have a configuration or design for a structure that provides the component an ability to perform the action or operation that is described in the illustrative examples as being performed by the component. Further, To the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. For example, other illustrative examples can be applied to comparing differences between images, experimental timeseries, and other types of data. Further, different illustrative examples may provide different features as compared to other desirable examples. The example or examples selected are chosen and described in order to best explain the principles of the examples, the practical application, and to enable others of ordinary skill in the art to understand the disclosure for various examples with various modifications as are suited to the particular use contemplated.

What is claimed is:

1. A model management system comprising:
a computer system;
a model manager in the computer system, wherein the model manager is configured to:
train a machine learning model to output predicted test results for sets of simulation values for a set of simulation parameters using a training data set, determined based on test results for a set of physical structures, to form a surrogate model;
select a set of current simulation values for the set of simulation parameters using the surrogate model and a cost function;
generate simulation test results using a physics simulation model that implements the set of current simulation values selected for the set of simulation parameters;
compare the simulation test results with physical test results from testing the set of physical structures using physical test inputs applied to the set of physical structures to form a comparison; and
train the surrogate model using the set of current simulation values selected for the set of simulation parameters using the surrogate model in response to the comparison being outside of a tolerance.

2. The model management system of claim 1, wherein the model manager is configured to:
repeat selecting the set of current simulation values for the set of simulation parameters, generating the simulation test results, and comparing the simulation test results with the test results in response to the comparison being outside of the tolerance.

3. The model management system of claim 1, wherein in selecting the set of current simulation values for the set of simulation parameters using the surrogate model and the cost function, the model manager is configured to:
select the set of current simulation values for the set of simulation parameters in which the surrogate model outputs predicted test results closest to the physical test results using the cost function in an optimization algorithm.

4. The model management system of claim 1, wherein the model manager is configured to:
run simulations using the physics simulation model implementing the set of current simulation values selected that resulted in the comparison being with in the tolerance.

5. The model management system of claim 1, wherein the training data set comprises physical test inputs applied to the set of physical structures and test results from applying a set of the physical test inputs to the set of physical structures, wherein the machine learning model outputs the predicted test results in response to physical test inputs input into the machine learning model.

6. The model management system of claim 1, wherein the machine learning model is selected from one of a Bayesian Gaussian process regression machine learning model, a neural network, and a regression machine learning model.

7. The model management system of claim 1, wherein the physics simulation model is one of a finite element analysis (FEA) model, a computational fluid dynamics (CFD) model, and a computational electromagnetics (CEM) model.

8. The model management system of claim 1, wherein the set of simulation parameters is selected from at least one of a material parameter or a model parameter.

9. The model management system of claim 1, wherein the set of current simulation values is selected from at least one of a material value or a model value.

10. A method for managing a physics simulation model, the method comprising:
training, by a computer system, a machine learning model to output predicted test results for sets of simulation values for a set of simulation parameters using a training data set that has been determined based on test results for a set of physical structures, wherein the training of the machine learning model results in generation of a surrogate model;
selecting, by the computer system, a set of current simulation values for the set of simulation parameters using the surrogate model and a cost function;
generating, by the computer system, simulation test results using the physics simulation model that implements the set of current simulation values selected for the set of simulation parameters;
comparing, by the computer system, the simulation test results with physical test results from testing the set of physical structures using physical test inputs applied to the set of physical structures to form a comparison; and
training, by the computer system, the surrogate model using the set of current simulation values selected for the set of simulation parameters using the surrogate model in response to the comparison being outside of a tolerance.

11. The method of claim 10 further comprising:
repeating, by the computer system, selecting the set of current simulation values for the set of simulation parameters, generating the simulation test results, and comparing the simulation test results with the test results in response to the comparison being outside of the tolerance.

12. The method of claim 10, wherein selecting the set of current simulation values for the set of simulation parameters using the surrogate model and the cost function comprises:
selecting, by the computer system, the set of current simulation values for the set of simulation parameters in which the surrogate model outputs predicted test results closest to the physical test results using the cost function in an optimization algorithm.

13. The method of claim 10 further comprising:
running, by the computer system, simulations using the physics simulation model implementing the set of current simulation values selected that resulted in the comparison being with in the tolerance.

14. The method of claim 10, wherein the training data set comprises physical test inputs applied to the set of physical structures and test results from applying a set of the physical test inputs to the set of physical structures, wherein the machine learning model outputs the predicted test results in response to physical test inputs input into the machine learning model.

15. The method of claim 10, wherein the machine learning model is selected from one of a Bayesian Gaussian process regression machine learning model, a neural network, and a regression machine learning model.

16. The method of claim 10, wherein the physics simulation model is one of a finite element analysis (FEA) model, a computational fluid dynamics (CFD) model, and a computational electromagnetics (CEM) model.

17. The method of claim 10, wherein the set of simulation parameters is selected from at least one of a material parameter or a model parameter and wherein current simulation values is selected from at least one of a material value or a model value.

18. A computer program product for managing a physics simulation model, the computer program product comprising a computer readable storage medium having program code embodied therewith, the program code executable by a computer system to cause the computer system to perform a method of:
training, by the computer system, a machine learning model to output predicted test results for sets of simulation values for a set of simulation parameters using a training data set that has been determined based on test results for a set of physical structures, wherein the training of the machine learning model results in generation of a surrogate model;
selecting, by the computer system, a set of current simulation values for the set of simulation parameters using the surrogate model and a cost function;
generating, by the computer system, simulation test results using the physics simulation model that implements the set of current simulation values selected for the set of simulation parameters;
comparing, by the computer system, the simulation test results with physical test results from testing the set of physical structures using physical test inputs applied to the set of physical structures to form a comparison; and
training, by the computer system, the surrogate model using the set of current simulation values selected for the set of simulation parameters using the surrogate model in response to the comparison being outside of a tolerance.

19. The computer program product of claim 18 further comprising:
repeating, by the computer system, selecting the set of current simulation values for the set of simulation parameters, generating the simulation test results, and comparing the simulation test results with the test results in response to the comparison being outside of the tolerance.

20. The computer program product of claim 19, wherein selecting the set of current simulation values for the set of simulation parameters using the surrogate model and the cost function comprises:
selecting, by the computer system, the set of current simulation values for the set of simulation parameters in which the surrogate model outputs predicted test results closest to the physical test results using the cost function in an optimization algorithm.
